(19) United States
(12) Patent Application Publication
(10) Pub. No.: US 2024/0024745 A1
(43) Pub. Date: Jan. 25, 2024

(54) PICKLEBALL RACKET AND ITS PREPARATION METHOD

(71) Applicant: Liuzhou ZHOU, Guangdong (CN)

(72) Inventor: Liuzhou ZHOU, Guangdong (CN)

(21) Appl. No.: 17/897,247

(22) Filed: Aug. 29, 2022

(30) Foreign Application Priority Data
Jul. 22, 2022 (CN) 202210871913.5

(51) Int. Cl. A63B 59/45; A63B 60/54; A63B 60/08; B29C 70/46; B29C 70/54; B29B 11/16

(52) U.S. Cl. CPC A63B 59/45; A63B 60/54; A63B 60/08; B29C 70/46; B29C 70/54; B29B 11/16; A63B 2209/023; B29K 2063/00

(57) ABSTRACT

Disclosed are a pickleball racket and its preparation method. The pickleball racket includes a racket body and a handle. The handle is connected to one side of the racket body. The racket body sequentially includes, from top to bottom, an upper panel, a lower panel and an inner composite panel sandwiched between the upper panel and the lower panel. The inner composite panel is formed by bonding an upper honeycomb panel, a shock absorption layer and a lower honeycomb panel sequentially from top to bottom. The upper and lower honeycomb panels are each provided with a honeycomb structure. The upper and lower panels are integrally formed by high-temperature molding and evenly wrap the outer side of the inner composite panel. An edge wrapping strip is evenly arranged between a side edge of the inner composite panel and the upper panel and between the side edge and the lower panel.

### BACKGROUND OF THE INVENTION

The invention relates to the technical field of sports goods, and more particularly, to a pickleball racket and its preparation method.

Pickleball is a sport of hitting a ball with a racket. It originated from Bunnbridge Island in Seattle, USA. It is a mixed sport of tennis, badminton and table tennis. Pickleball has become a regular sport in PE classes of middle schools, and has gradually become popular with young and old.

Ordinary pickleball rackets are made of wooden boards or carbon fiber or glass fiber. Pickleball rackets made of wooden boards are heavy and hard with poor handfeel and poor shock absorption. When players play this sport with the rackets, they may easily get a sore arm or wrist injury due to the heavy weight. The rackets have poor elasticity, poor gripping feeling, poor durability and short service life, which not only causes certain economic losses, but also has potential safety hazards to a certain extent, causing certain dangers to the players. Therefore, it is a technical problem to be solved at present to provide a pickleball racket with good gripping feeling, good shock absorption, and light weight.

### BRIEF SUMMARY OF THE INVENTION

The objective of the invention is to solve the above technical problems, and provide a pickleball racket with good gripping feeling, good shock absorption effect, and light weight and its preparation method.

In order to achieve the above objective, the invention adopts the following technical solution: a pickleball racket, including a racket body and a handle, wherein the handle is connected to one side of the racket body, the racket body includes an upper panel, a lower panel and an inner composite panel sandwiched between the upper panel and the lower panel in sequence from top to bottom, the inner composite panel is formed by bonding an upper honeycomb panel, a shock absorption layer and a lower honeycomb panel in sequence from top to bottom, the upper honeycomb panel and the lower honeycomb panel are each provided with a honeycomb structure, the upper panel and the lower panel are arranged in an integrally formed structure, and evenly wrap the outer side of the inner composite panel, and an edge wrapping strip is evenly arranged between a side edge of the inner composite panel and the upper panel and between the side edge of the inner composite panel and the lower panel.

Preferably, the upper panel and the lower panel are both made from a fiber prepreg, the outer layer of the fiber prepreg is one of carbon fiber, glass fiber, and Kevlar composite fiber, and the interior of the fiber prepreg is one of epoxy resin, polyester resin and a thermoplastic resin material.

Preferably, the upper honeycomb panel and the lower honeycomb panel are both made from one of PP polypropylene, an aromatic paper honeycomb material and an aluminum honeycomb material.

Preferably, the shock absorption layer is composed of a shock absorbing rubber material.

Preferably, the edge wrapping strip is filled with a polyurethane foam material.

Preferably, the inner composite panel is integrally formed by hot pressing.

Preferably, the upper panel, the lower panel, the inner composite panel sandwiched between the upper panel and the lower panel, and the edge wrapping strip are formed by hot pressing at a high temperature of 140° C.

Preferably, the handle includes a connecting portion and a grip portion, the connecting portion is respectively connected with a top end of the grip portion and a bottom end of the racket body, the bottom of the handle is provided with a bottom cover, and a side where the handle is connected with the racket body is wider than the other side, forming a wide-top narrow-bottom shape.

Preferably, the connecting portion and the grip portion of the handle are covered and bonded by a circle of PU sheet, and the material of the PU sheet is epoxy resin.

Preferably, a protective layer is arranged on an outer side of each of the upper panel and the lower panel.

Preferably, a preparation method of the pickleball racket includes the following steps:
S1: weaving: weaving carbon fiber or glass fiber, together with epoxy resin, into cloth;
S2: material preparation: preparing materials;
S3: cutting; cutting the cloth into the specifications required for the structure;
S4: rolling: rolling the cut cloth into a strip first;
S5: preformation: carrying out preformation;
S6: mold loading: loading the preformed product into a molding mold;
S7: high-temperature molding: pressing at a high temperature of 140° C. to 150° C. for 17 min to 25 min;
S8: demolding: carrying out cooling and demolding after pressing; and
S9: coating: carrying out grinding, polishing, paint spraying, and labeling on a rough blank to form coating.

Compared with the prior art, the invention provides a pickleball racket and its preparation method, which have the following beneficial effects:

1. The invention achieves the effects of shock absorption and noise reduction by arranging the shock absorption layer made of rubber, thus improving the SPIN.

2. The inner composite panel formed by bonding the upper honeycomb panel, the shock absorption layer and the lower honeycomb panel is pressed at a high temperature into an integral structure. Moreover, through the combined use of panels and composite panels of different materials, the weight, vibration, hardness and other structural characteristics of the racket are changed, thus achieving good gripping feeling, good shock absorption effect, and light weight.

3. The invention uses one of PP polypropylene, aromatic paper honeycomb and aluminum honeycomb as the upper honeycomb panel, which can produce different striking effects. Moreover, the honeycomb structure has good durability and environmental resistance.

4. In the invention, the composite inner panel is filled with a circle of polyurethane foam material, and then the polyurethane foam material is heated. Through heating, the polyurethane foam material has the advantages of no gap after filling, strong bonding after curing, shock and compression resistance, no cracking, corrosion, or falling off after curing, heat resistance and heat insulation, high-efficiency insulation, sound insulation, and waterproofness and moisture-proofness after curing.

5. According to the invention, the handle design of the PU sheet material and the grip portion having a wide-top narrow-bottom shape achieves better comfort and experience. In the meanwhile, the bottom cover is arranged at the bottom of the handle to achieve the purpose of absorbing sweat through holes.

6. The manufacturing process of the invention adopts the manufacturing process of high-temperature integrated molding, which reduces the manufacturing steps of the racket and improves the production efficiency. The upper panel, the lower panel, the inner composite panel and the edge wrapping strip are attached at a high temperature and a high pressure, and there will be no glue shortage or delamination. Moreover, this racket is light in weight and has a long service life.

### BRIEF DESCRIPTION OF THE DRAWINGS

FIG. 1 shows schematic diagram 1 of the overall structure of the invention;

FIG. 2 is an enlarged view of A-A in the overall structure schematic diagram of the invention;

FIG. 3 is a sectional view of a racket body according to the invention; and

FIG. 4 shows schematic diagram 2 of the overall structure of the invention.

In the figures: 1, racket body; 11, upper panel; 12, lower panel; 13, inner composite panel; 131, upper honeycomb panel; 132, shock absorption layer; 133, lower honeycomb panel; 2, handle; 21, connecting portion; 22, grip portion; 23, bottom cover; 24, PU sheet; 3, edge wrapping strip.

### DETAILED DESCRIPTION OF THE INVENTION

The technical solutions in the embodiments of the invention will be described clearly and completely below in connection with the drawings in the embodiments of the invention, and it will be apparent that the embodiments described here are merely a part, not all of the embodiments of the invention.

In the description of the invention, it is to be understood that the orientations or positional relationships, indicated by the terms, such as “upper”, “lower”, “front”, “rear”, “left”, “right”, “top”, “bottom”, “inside”, and “outside”, are based on the orientations or positional relationships shown in the drawings and are only for the purpose of facilitating and simplifying the description of the invention, rather than indicating or implying that the described device or element must have a particular orientation or must be constructed and operated in a particular orientation, and therefore they cannot to be construed as limiting the invention.

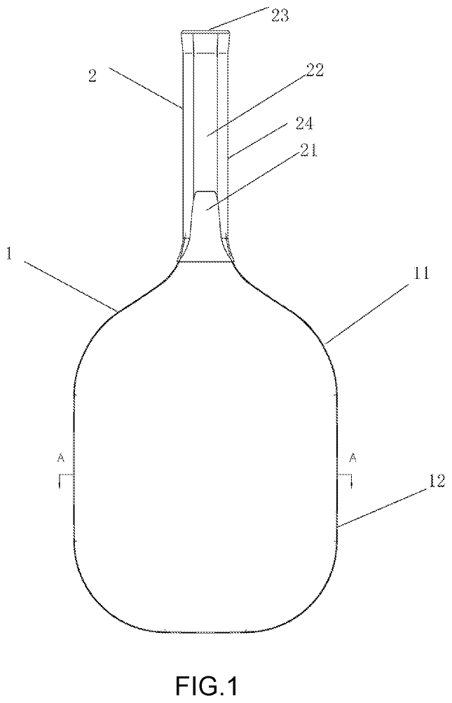

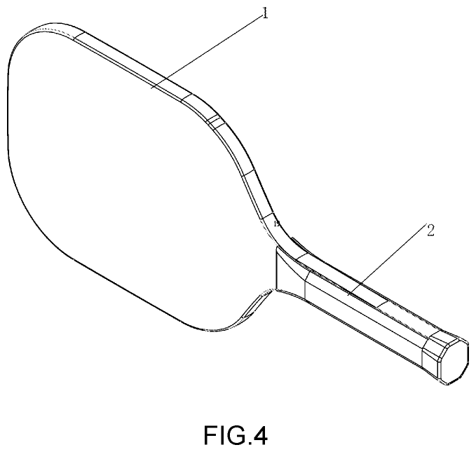

Referring to FIGS. 1 to 4, the pickleball racket according to the invention includes a racket body 1 and a handle 2, wherein the handle 2 is connected to one side of the racket body 1, the racket body 1 includes an upper panel 11, a lower panel 12 and an inner composite panel 13 sandwiched between the upper panel 11 and the lower panel 12 in sequence from top to bottom. The inner composite panel 13 is formed by bonding an upper honeycomb panel 131, a shock absorption layer 132 and a lower honeycomb panel 133 in sequence from top to bottom. The upper honeycomb panel 131 and the lower honeycomb panel 133 are each provided with a honeycomb structure. The upper panel 11 and the lower panel 12 are arranged in an integrally formed structure, and evenly wrap the outer side of the inner composite panel 13. An edge wrapping strip 13 is evenly arranged between a side edge of the inner composite panel 13 and the upper panel 11 and between the side edge of the inner composite panel 13 and the lower panel 12.

The invention achieves the effect of shock absorption and noise reduction by arranging the shock absorption layer 132 made of rubber material, thus improving the SPIN. The inner composite panel 13 formed by bonding the upper honeycomb panel 131, the shock absorption layer 132 and the lower honeycomb panel 133 is hot-pressed at a high temperature into an integral structure. Moreover, through the combined use of panels and composite panels 13 of different materials, the weight, vibration, hardness and other structural characteristics of the racket are changed, thus achieving good gripping feeling, good shock absorption effect, and light weight.

In an optional embodiment, as shown in FIG. 3, the upper panel 11 and the lower panel 12 in the invention are both made from a fiber prepreg, the outer layer of the fiber prepreg is one of carbon fiber, glass fiber, and Kevlar composite fiber, and the interior of the fiber prepreg is one of epoxy resin, polyester resin and a thermoplastic resin material.

The upper panel 11 and the lower panel 12 in the invention are both made from a fiber prepreg, and the outer layer of the fiber prepreg is one of carbon fiber, glass fiber, and Kevlar composite fiber, after the upper panel 11, the lower panel 12 and the inner composite panel 13 are bonded, the obtained structure is put into a mold and formed at a high temperature. This design is simple in structure and light in weight, which improves the user's experience and makes the sport more interesting.

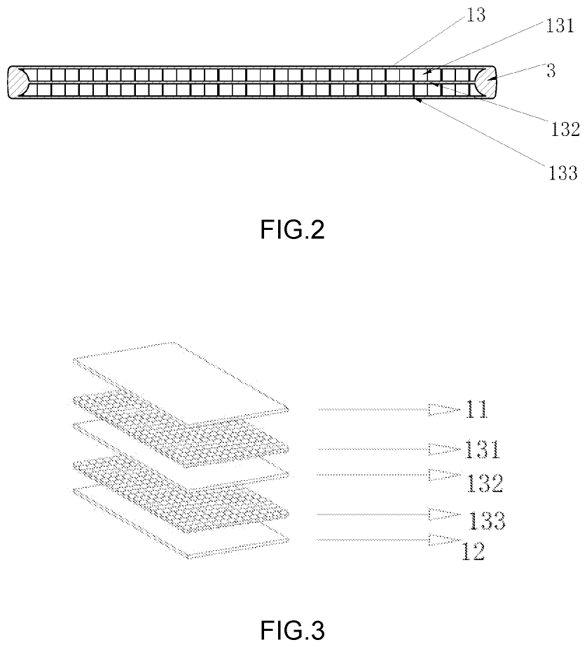

In an optional embodiment, as shown in FIGS. 2 to 3, the upper honeycomb panel 131 and the lower honeycomb panel 133 are both made from one of PP polypropylene, an aromatic paper honeycomb material and an aluminum honeycomb material.

The invention uses one of PP polypropylene, aromatic paper honeycomb and aluminum honeycomb as the upper honeycomb panel, which can produce different striking effects. Moreover, the honeycomb structure has good durability and environmental resistance.

In an optional embodiment, as shown in FIGS. 2 to 3, the shock absorption layer 132 of the invention is composed of a shock absorbing rubber material.

The invention achieves the effects of shock absorption and noise reduction by arranging the shock absorption layer 132 made of rubber, thus improving the SPIN.

In an optional embodiment, as shown in FIG. 2, the edge wrapping strip 3 of the invention is filled with a polyurethane foam material.

In the invention, the composite inner panel 13 is filled with a circle of polyurethane foam material, and then the polyurethane foam material is heated. Through heating, the purposes of no gap after filling, strong bonding after curing, shock and compression resistance, no cracking, corrosion, or falling off after curing, heat resistance and heat insulation, high-efficiency insulation, sound insulation, and waterproofness and moisture-proofness after curing.

In an optional embodiment, as shown in FIG. 3, the inner composite panel 13 of the invention is integrally formed by hot pressing. The upper panel 11, the lower panel 12 and the inner composite panel 13 sandwiched between the upper panel 11 and the lower panel 12 are formed by hot pressing at a high temperature of 140° C.

In the invention, the upper panel 11, the lower panel 12, the inner composite panel 13, and the edge wrapping strip 3 are put into a mold after being bonded, and are hot-pressed at a high temperature of 140° C. The structure is simple and the practicability is higher.

In an optional embodiment, as shown in FIG. 1, the handle 2 of the invention includes a connecting portion 21 and a grip portion 22, the connecting portion 21 is respectively connected with a top end of the grip portion 22 and a bottom end of the racket body 1, the bottom of the handle 2 is provided with a bottom cover 23, and a side where the handle 2 is connected with the racket body 1 is wider than the other side, forming a wide-top narrow-bottom shape. The connecting portion 21 and the grip portion 22 of the handle 2 are covered and bonded by a circle of PU sheet 24, and the material of the PU sheet 24 is epoxy resin.

According to the invention, the connecting portion 21 and the grip portion 22 are wrapped by the PU sheet 24, and the handle wrapped by the PU sheet is designed to be wide at the top and narrow at the bottom, which is more comfortable to hold and has a better experience. In the meanwhile, the bottom cover 23 is arranged at the bottom of the handle 2 to achieve the purpose of absorbing sweat through holes.

In an optional embodiment, as shown in FIGS. 1 to 3, a protective layer is arranged on an outer side of each of the upper panel 11 and the lower panel 12 of the invention.

In the invention, another protective layer can be arranged additionally on the outer layers of the upper panel 11 and the lower panel 12 according to the user's needs, so as to meet different usage scenarios and actual needs.

In an optional embodiment, the preparation method of the pickleball racket includes the following steps:
S1: weaving: weaving carbon fiber or glass fiber, together with epoxy resin, into cloth;
S2: material preparation: in accordance with a design structure list, preparing carbon fiber or glass fiber, epoxy resin, a fiber prepreg, PP polypropylene or aromatic paper honeycomb or aluminum honeycomb, and a shock absorbing rubber material;
S3: cutting: in accordance with the design structure, cutting a large piece of cloth-like yarn such as carbon fiber cloth into small pieces of the specifications required by the structure;
S4: rolling: rolling the cut cloth-like yarn into a long strip first;
S5: preformation: shaping the rolled strip as a pickleball racket and carrying out preformation;
S6: mold loading: loading the preformed product into a molding mold;
S7: high-temperature molding: pressing at a high temperature of 140° C. to 150° C. for 17 min to 25 min to achieve integral molding by high-temperature pressing;
S8: demolding: carrying out cooling and demolding on the product after pressing; and
S9: coating: carrying out grinding, polishing, paint spraying, and labeling on a rough blank to form coating.

The manufacturing process of the invention adopts the manufacturing process of high-temperature integrated molding, which reduces the manufacturing steps of the racket and improves the production efficiency. The upper panel, the lower panel, the inner composite panel and the edge wrapping strip are attached at a high temperature and a high pressure, and there will be no glue shortage or delamination. Moreover, this racket is light in weight and has a long service life.

The above descriptions are only preferred embodiments of the invention, but the scope of the invention is not limited to thereto. Any equivalent replacements or changes, made according to the technical solutions and inventive concept of the invention by those familiar with the art within the technical scope disclosed by the invention, shall be included within the scope of the invention.

What is claimed is:

1. A pickleball racket, comprising a racket body (1) and a handle (2), wherein the handle (2) is connected to one side of the racket body (1), the racket body (1) comprises an upper panel (11), a lower panel (12) and an inner composite panel (13) sandwiched between the upper panel (11) and the lower panel (12) in sequence from top to bottom, the inner composite panel (13) is formed by bonding an upper honeycomb panel (131), a shock absorption layer (132) and a lower honeycomb panel (133) in sequence from top to bottom, the upper honeycomb panel (131) and the lower honeycomb panel (133) are each provided with a honeycomb structure, the upper panel (11) and the lower panel (12) are arranged in an integrally formed structure, and evenly wrap the outer side of the inner composite panel (13), and an edge wrapping strip (3) is evenly arranged between a side edge of the inner composite panel (13) and the upper panel (11) and between the side edge of the inner composite panel (13) and the lower panel (12).

2. The pickleball racket according to claim 1, wherein the upper panel (11) and the lower panel (12) are both made from a fiber prepreg, the outer layer of the fiber prepreg is one of carbon fiber, glass fiber, and Kevlar composite fiber, and the interior of the fiber prepreg is one of epoxy resin, polyester resin and a thermoplastic resin material.

3. The pickleball racket according to claim 1, wherein the upper honeycomb panel (131) and the lower honeycomb panel (133) are both made from one of PP polypropylene, an aromatic paper honeycomb material and an aluminum honeycomb material.

4. The pickleball racket according to claim 1, wherein the shock absorption layer (132) is composed of a shock absorbing rubber material.

5. The pickleball racket according to claim 1, wherein the edge wrapping strip (3) is filled with a polyurethane foam material.

6. The pickleball racket according to claim 1, wherein the inner composite panel (13) is integrally formed by hot pressing, the upper panel (11), the lower panel (12), the inner composite panel (13) sandwiched between the upper panel (11) and the lower panel (12), and the edge wrapping strip (3) are formed by hot pressing at a high temperature of 140° C.

7. The pickleball racket according to claim 1, wherein the handle (2) comprises a connecting portion (21) and a grip portion (22), the connecting portion (21) is respectively connected with a top end of the grip portion (22) and a bottom end of the racket body (1), the bottom of the handle (2) is provided with a bottom cover (23), and a side where the handle (2) is connected with the racket body (1) is wider than the other side, forming a wide-top narrow-bottom shape.

8. The pickleball racket according to claim 1, wherein the connecting portion (21) and the grip portion (22) of the handle (2) are covered and bonded by a circle of PU sheet (24), and the material of the PU sheet (24) is epoxy resin.

9. The pickleball racket according to claim 1, wherein a protective layer is arranged on an outer side of each of the upper panel (11) and the lower panel (12).

10. A preparation method of a pickleball racket, comprising the following steps:
S1: weaving: weaving carbon fiber or glass fiber, together with epoxy resin, into cloth;
S2: material preparation: preparing materials;
S3: cutting; cutting the cloth into the specifications required for the structure;
S4: rolling: rolling the cut cloth into a strip first;
S5: preformation: carrying out preformation;
S6: mold loading: loading the preformed product into a molding mold;
S7: high-temperature molding: pressing at a high temperature of 140° C. to 150° C. for 17 min to 25 min;
S8: demolding: carrying out cooling and demolding after pressing; and
S9: coating: carrying out grinding, polishing, paint spraying, and labeling on a rough blank to form coating.
